(19) United States
(12) Patent Application Publication
(10) Pub. No.: US 2023/0144887 A1
(43) Pub. Date: May 11, 2023

(54) Camera Assembly

(71) Applicant: Portable Multimedia Ltd., West End Surrey (GB)

(72) Inventors: Robert George Grant, West End Surry (GB); Graham Keith Lambert, West End Surrey (GB); Ceri Hill, West End Surrey (GB)

(73) Assignee: Portable Multimedia Ltd., West End Surrey (GB)

(21) Appl. No.: 18/150,536

(22) Filed: Jan. 5, 2023

Related U.S. Application Data
(63) Continuation-in-part of application No. 16/263,348, filed on Jan. 31, 2019, now abandoned.

(30) Foreign Application Priority Data
Jan. 7, 2019 (GB) 1900216.1

(51) Int. Cl. H04N 23/90; H04N 23/51; H04N 23/54; B60R 11/04

(52) U.S. Cl. CPC H04N 23/90; H04N 23/51; H04N 23/54; B60R 11/04; B60R 2011/0003

(57) ABSTRACT

A first image capture device is operative to capture images in a first direction, the first image capture device comprising a first coupling configured to receive a complementary coupling of a second image capture device; the first image capture device further comprising a housing, a portion of which comprises a recessed area in the surface of the housing of the first image capture device; a second image capture device removably coupleable to said first image capture device and operative to capture images in a second direction different to the first direction, the second image capture device comprising a second coupling; the second image capture device further comprising a housing, a portion of which comprises a lug extending from the surface of the housing, wherein the first and second couplings are configured to electro-mechanically couple the second image capture device to the first image capture device by complementary inter-engagement.

### CROSS-REFERENCE TO RELATED APPLICATIONS

The present application is a continuation-in-part of co-pending U.S. patent application Ser. No. 16/263,348 filed on Jan. 31, 2019, which claims priority from U.K. Patent Application No. GB 1900216.1 filed on Jan. 7, 2019, all of which are hereby incorporated herein by reference.

### TECHNICAL FIELD

The present invention relates to a camera assembly, first image capture device and second image capture device. In particular, but not exclusively, the present invention relates to a camera assembly, first image capture device and second image capture device for use in a vehicle.

### BACKGROUND

Camera systems for vehicles such as, for example, on-board camera systems, dashboard cameras, in-vehicle systems, etc. are increasing in use and popularity. Such camera systems are sometimes referred to as “Dash Cams” because they are often situated on a vehicle dashboard. They are often installed into a vehicle after the overall vehicle has been manufactured, as an “after-sales” modification or personalisation of the vehicle by a user and are employed. as a means to capture images of an area in and/or around a vehicle. Images captured by such systems may be used as evidence in the case of an accident, damage, or the like. Often, such camera systems are configured to continuously record video footage of a view through a windscreen of a vehicle in which they are mounted. Such camera systems may be attached to the interior of the vehicle windscreen or to the top of the dashboard of the vehicle.

Some known camera systems are operative to capture an image, a sequence of images, and/or record video footage when the vehicle is started, responsive to a user input, and/or automatically responsive to detection of movement of the vehicle.

Known camera systems typically capture image and/or video data in a cyclic buffered manner, i.e. regularly recording and overwriting data when the data is no longer relevant, for example after a period of time deemed to be sufficiently long for the data not to comprise relevant data, and storing a segment of the buffered data securely on a memory device responsive to a dangerous event e.g. a collision.

Typically, a camera is mounted to the superstructure of the vehicle or window by way of an adhesive or suction attachment coupled to the camera through an arm so that the camera field of view is not obstructed by the adhesive or suction attachment or superstructure of the vehicle. Optionally, the arm may be movably attached to one other or both of the attachment or camera. Such movable attachment may be by way of a ball and socket joint in which the ball may be tightened around the socket by way of a screw thread and nut arrangement or some other mechanism may be utilised for maintaining the orientation of the arm once it has been moved to a desired position. A camera mounted to the vehicle in such a manner may be positioned to capture images in front of the vehicle. Alternatively, a camera may be positioned as a rear facing camera and may be mounted adjacent or on a rear window of a vehicle to provide a field of view through the rear window of the vehicle. Some vehicle owners may install both a forward-facing camera and a rearward-facing camera to capture images from both in front and behind the vehicle.

Installation of data and/or power cables for such a dual camera arrangement may be time consuming. Additionally, obtaining two separate cameras for such a dual camera arrangement may be expensive.

To address such issues, a multi-directional camera has been devised. Such a camera comprises two lenses that are pivotable relative to a camera body to point in respective desired directions. This is at the choosing of the user, but typically, if such a camera is mounted toward the front of a vehicle, one lens would be oriented to capture images from in front of the vehicle and the other lens would be oriented to capture images from behind the vehicle (i.e. with a field of view to the rear of the vehicle, but which would also include at least some of the interior of the vehicle).

Whilst a camera that is capable of capturing images from two directions may be desirable, the known camera comprises a single unit with both lenses integral with the unit. This may be undesirable in some circumstances, for instance where the ability to capture images from a second direction is not required. Additionally, such a camera may be complex and/or expensive to manufacture and may also be expensive to potential purchasers.

The present invention has been devised with the foregoing in mind.

### SUMMARY

According to an aspect of the present invention, there is provided a camera assembly, comprising a first image capture device operative to capture images in a first direction, the first image capture device comprising a first coupling configured to receive a complementary coupling of a second image capture device; the first image capture device further comprising a housing, a portion of which comprises a recessed area in the surface of the housing of the first image capture device; a second image capture device removably coupleable to said first image capture device and operative to capture images in a second direction different to the first direction, the second image capture device comprising a second coupling; the second image capture device further comprising a housing, a portion of which comprises a lug extending from the surface of the housing, wherein the first and second couplings are configured to electro-mechanically couple the second image capture device to the first image capture device by complementary inter-engagement of said first and second couplings; wherein the lug and the recessed area act to provide a guide for inter-engaging the first coupling with the second coupling; and further wherein images captured by said second image capture device are transferrable to said first image capture device via coupled first and second couplings.

Optionally, said first coupling comprises a female configuration and said second coupling comprises a male configuration. Locating the female connector in a “master” unit, which is more likely to be heavier than the “slave” unit may offer support to the slave unit, which is likely to be lighter.

Optionally, said first and second image capture devices are operative to capture a series of images comprising video footage. When used as a “dashcam”, the ability to capture video footage, instead of static images, may give a user a higher probability of understanding what happened during a driving incident.

Optionally, said first coupling is further configured to receive a coupling element of a data transfer element to communicate images captured by said first image capture device and/or second image capture device to a remote device via said data transfer element. Thus, a common output connector of the first image capture device can be used as the connector to which a second image capture device is connected to form the camera assembly.

Optionally, the first coupling and second coupling comprise couplings compatible with video transfer connectors. Further optionally, said first coupling and second coupling comprise High Definition video connectors.

Optionally, said first coupling comprises a plurality of connectors and said second coupling comprises a plurality of complementary connectors, each one of said plurality of complementary connectors engageable with a corresponding one of said plurality of connectors.

Optionally, at least one of said plurality of connectors is unassigned and at least one of said plurality of complementary connectors is unassigned and further wherein transfer of images captured by said second image capture device to said first image capture device is via said at least one unassigned complementary connectors and respective unassigned connectors.

Optionally, said first and second image capture devices further comprise magnetic coupling elements disposed on respective opposed surfaces thereof that are opposed when said first and second image capture devices are coupled, said magnetic coupling elements arranged to attract said first image capture device to said second image capture device, and vice versa, to maintain a coupling orientation through a coupling/decoupling operation and to removably couple said first image capture device to said second image capture device.

Use of magnets as part of the first and second couplings offer a coupling force as well as alignment assistance during a coupling operation of the first and second image capture devices.

Optionally, said magnetic coupling elements comprise rare-earth magnets. Further optionally, the magnetic coupling elements may comprise neodymium magnets.

Optionally, said camera assembly comprises a bi-directional camera assembly. Further optionally, said second direction is an opposite direction to said first direction. Thus, when the camera assembly is located in a vehicle, one image capture device may be directed in a forward direction to capture images from in front of a vehicle and the other image capture device may be directed in a rearward direction to capture images from behind the vehicle (and/or from a cabin of the vehicle).

According to another aspect of the present invention, there is provided a first image capture device for use in a camera assembly as described above and hereinafter, the first image capture device operative to capture images in a first direction, the first image capture device comprising a first coupling configured to receive a complementary coupling of a second image capture device operative to capture images in a second, different direction and to removably couple said first image capture device to a second image capture device; the first image capture device further comprising a housing, a portion of which comprises a recessed area in the surface of the housing; the first coupling further configured to electro-mechanically couple the first image capture device to a second image capture device by complementary inter-engagement of said first coupling with a second coupling of a second image capture device; wherein the recessed area acts to provide a guide for inter-engagement of the first coupling with the second coupling by complementary inter-engagement with a lug extending from the surface of a housing of a second image capture device; and further wherein images captured by a second image capture device coupled to the first image capture device are transferrable to said first image capture device via a coupling between the first coupling and a complementary coupling of a second image capture device.

Optionally, said first coupling comprises a female configuration.

Optionally, said first image capture device is operative to capture a series of images comprising video footage.

Optionally, said first coupling is further configured to receive a coupling element of a data transfer element to communicate captured images to a remote device via said data transfer element.

Optionally, said first coupling comprises a coupling compatible with a video transfer connector.

Optionally, said first coupling comprises a High Definition video connector.

Optionally, said first coupling comprises a plurality of connectors, each one of said plurality of connectors engageable with a corresponding one of a plurality of complementary connectors of a second coupling of a second image capture device.

Optionally, at least one of said plurality of connectors is unassigned and further wherein transfer of images captured by a second image capture device to said first image capture device is via at least one unassigned complementary connector of a second coupling of a second image capture device and respective unassigned connector of said first image capture device.

Optionally, said first image capture device further comprises a magnetic coupling element disposed on a surface thereof that is opposite an opposing surface of a second image capture device when said first and second image capture devices are coupled, said magnetic coupling element arranged to attract said first image capture device to a second image capture device, and vice versa, to maintain a coupling orientation through a coupling/decoupling operation and to removably couple said first image capture device to a second image capture device.

Optionally, said magnetic coupling element comprises a rare-earth magnet.

Optionally, said rare-earth magnet comprises neodymium.

Optionally, said first direction is an opposite direction to said second direction.

According to another aspect of the present invention, there is provided a second image capture device for use in a camera assembly as described above and hereinafter and removably couplable to a first image capture device for capturing images in a first direction as described above and hereinafter, the second image capture device removably couplable to a first image capture device and operative to capture images in a second direction different to the first direction, the second image capture device comprising a second coupling, the second image capture device further comprising a housing, a portion of which comprises a lug extending from the surface of the housing, the second coupling further configured to electro-mechanically couple the second image capture device to the first image capture device by complementary inter-engagement of said second coupling with a first coupling of a first image capture device, wherein the lug acts to provide a guide for inter-engagement of the first coupling with the second coupling by complementary inter-engagement with a recessed area in the surface of the housing extending from the surface of a housing of a first image capture device; and further wherein images captured by the second image capture device coupled to a first image capture device are transferrable to a first image capture device via a coupling between the second coupling and a complementary coupling of a first image capture device.

Optionally, said second image capture device is operative to capture a series of images comprising video footage.

Optionally, said second coupling comprises a coupling compatible with a video transfer connector.

Optionally, said second coupling comprises a High Definition video connector.

Optionally, said second coupling comprises a plurality of connectors, each one of said plurality of connectors engageable with a corresponding one of a plurality of complementary connectors of a first coupling of a first image capture device.

Optionally, at least one of said plurality of connectors is unassigned and further wherein transfer of images captured by the second image capture device to a first image capture device is via at least one unassigned connector of the second coupling of the second image capture device and a respective unassigned complementary connector of a first coupling of a first image capture device.

Optionally, said second image capture device further comprises a magnetic coupling element disposed on a surface thereof that is opposite an opposing surface of a first image capture device when said second image capture device and a first image capture device are coupled, said magnetic coupling element arranged to attract said second image capture device to a first image capture device, and vice versa, to maintain a coupling orientation through a coupling/decoupling operation and to removably couple said second image capture device to a first image capture device.

Optionally, said magnetic coupling element comprises a rare-earth magnet.

Optionally, rare-earth magnet comprises neodymium.

Optionally, said second direction is an opposite direction to said first direction.

### BRIEF DESCRIPTION OF THE DRAWINGS

One or more embodiments of the present invention are described further hereinafter, by way of example only, with reference to the accompanying drawings in which:

FIG. 1 illustrates end views of parts of a camera assembly in a decoupled state according to one or more embodiments of the present invention;

FIG. 2 illustrates a rear view of the camera assembly with the parts in a decoupled state; and

FIG. 3 illustrates a rear view of the camera assembly with the parts in a coupled state.

### DETAILED DESCRIPTION OF THE INVENTION

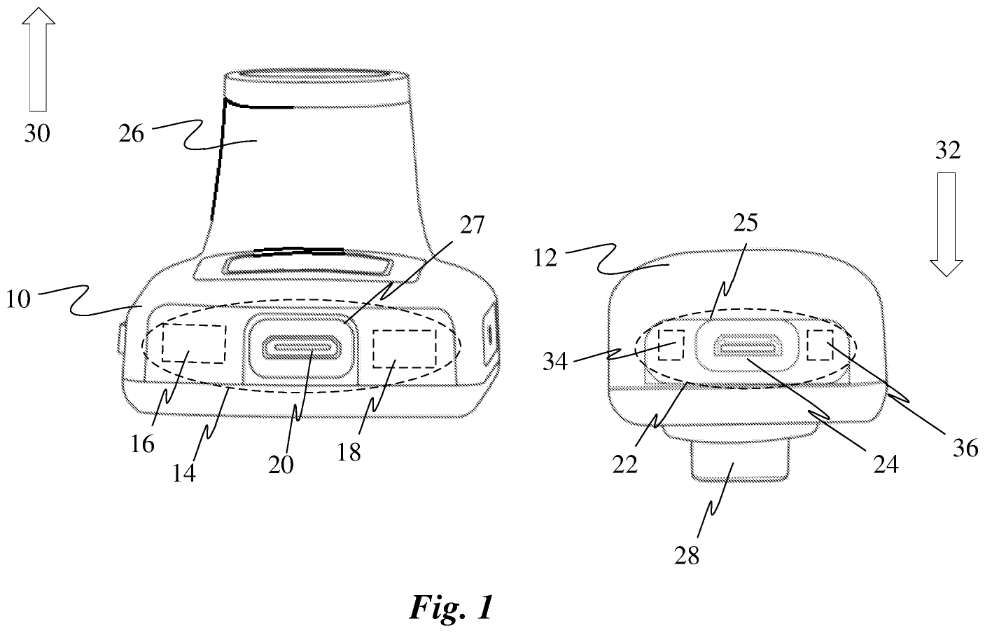

FIG. 1 is an illustrative schematic drawing comprising an isometric projection of a camera assembly comprising a first image capture device 10 and second image capture device 12 in a decoupled state. The first image capture device 10 comprises a first coupling 14 comprising one of more coupling elements and the second image capture device 12 comprises a second coupling 22 comprising one or more coupling elements. The first 14 and second 22 couplings are configured to be complimentary to each other and to be removably engageable to allow the first 10 and second 12 image capture devices to be removably coupled together. The coupling between the two image capture devises comprises an electro-mechanical coupling to permit the transfer of data and power between the devices. More specifically, when so-coupled, the devices are configured in a master-slave relationship, with the first image capture device 10 comprising the master device and the second image capture device 12 comprising the slave device. When coupled to the first image capture device 10, the second image capture device receives power from the first image capture device 10 via the electro-mechanical coupling and can transfer images that it captures to the first image capture device 10 via the electro-mechanical coupling.

The first image capture device 10 comprises a first camera 26 configured to face in a first direction 30. The first image capture device 10 is capable of recording live video and images to be processed on the first image capture device 10, or for processing on a remote device after upload thereto. The first camera 26 may be a CCD device or similar and capable of being incorporated with any combination of lenses, mirrors, polarising filters or other optical elements.

A coupling element of the first coupling 14 on first image capture device 10 comprises an electro-mechanical coupling. In the illustrated example, this comprises a high definition video connector 20. Other types of connector, e.g. USB, may be used in optional arrangements.

Such a high definition video connector 20 provides an electro-mechanical connection to another device via any complementary connector and serves to provide power and allow data transfer via the connector/complementary connector coupling. First image capture device 10 may be connected to an external device, such as a computer monitor or television, via the high definition video connector 20 (hereinafter “connector 20”) to view and/or transfer images captured from the image capture device 10. The connector 20 comprises a plurality of pins assigned to this image viewing (i.e. data transfer) functionality. In one or more embodiments of the present invention at least one pin will be of unassigned functionality. The unassigned functionality pin is used as a communication conduit to transfer data from a coupled second image capture device 12 to the first image capture device 10.

A further, optional, coupling element of the first coupling 14 of the first image capture device 10 comprises at least one magnetic element, which may comprise, in one example, one or more permanent magnets 16 and 18. Such magnets may comprise a rare earth material, such as, for example, neodymium. Optionally, and in order to reduce the likelihood that the magnet may lose its magnetism over time, a magnetic element with a high Curie point may be preferable. In some instances, it may be preferable to dispose the magnets 16, and 18 under the surface of a housing of the first camera device 10 so as to reduce the likelihood of the relatively brittle material of the magnets shattering, due to, for example, contact of surfaces of the magnet with any other surfaces.

The magnets 16 and 18 provide an attractive force to any other magnetic material (and/or ferrous material) which is brought into proximity to said magnets. It will be appreciated that this can either be other magnets or a material that is attracted to the first and second magnets 16 and 18.

The second image capture device 12 comprises a second camera 28 configured to face in a second direction 32. The second image capture device 12 can record live video and images to be processed on the second image capture device 12, or for processing on a remote device after upload thereto. The second camera 28 may be a CCD device or similar and capable of being incorporated with any combination of lenses, mirrors, polarising filters, or other optical elements. The images captured by the second image capture device may be serialised to be sent to the first image capture device 10.

A coupling element of the second coupling 22 on second image capture device 12 comprises an electro-mechanical coupling. In the illustrated example, this comprises a high-definition video connector 24. The high-definition video connector 24 (hereinafter “connector 24”) is complementary to the connector 20 of the first image capture device 10. Such connector 24 provides an electro-mechanical connection to the complementary connector 20.

Second image capture device 12 is removably connectable to an external device, such as the first image capture device 10, to view and/or transfer images captured from it. The connector 24 comprises a plurality of pins assigned to this image viewing (i.e. data transfer) functionality. In one or more embodiments of the present invention at least one pin will be of unassigned functionality. The unassigned functionality pin is used as a communication conduit to transfer data via the coupling between connectors 20 and 24 to the first image capture device 10.

A further, optional, coupling element of the second coupling 22 of the second image capture device 12 comprises at least one magnetic element, which may comprise, in one example, one or more permanent, non-ferrous magnets 34 and 36. Such non-ferrous magnets may comprise a rare earth material, such as, for example, neodymium. Optionally, and in order to reduce the likelihood that the magnet may lose its magnetism over time, a magnetic element with a high Curie point may be preferable. In some instances, it may be preferable to dispose the magnets 34 and 36 under the surface of a housing of the first camera device 10 so as to reduce the likelihood of the relatively brittle material of the magnets shattering, due to, for example, contact of surfaces of the magnet with any other surfaces.

The magnets 34 and 36 provide an attractive force to any other magnetic material (and/or ferrous material) which is brought into proximity to said magnets. It will be appreciated that this can either be other magnets or a material that is attracted to the first and second magnets 34 and 36.

In the illustrated example, a first mechanical coupling 27 is formed in a housing of the first image capture device 10 and has a shape that is complimentary to a second mechanical coupling 25 of the second coupling 22. The first mechanical coupling 27 may be a recessed area in the surface of the housing of the first image capture device 10 and the second mechanical coupling formation 25 may be a lug extending from the surface of the housing of the second image capture device 12. It can be seen that the shape of the first recess 27 matches the shape of lug 25. The lug 25 and recess 27 act to provide a guide for the first 10 and second 12 image capture devices when being coupled together and also act as a mechanical coupling joint, which mechanically couples the two devices together. This is in addition to a coupling between couplings 20 and 24. The coupling between couplings 25 and 27 serves to bear a greater portion of a mechanical load on the couplings between the two devices, compared to the mechanical load borne between couplings 20 and 24.

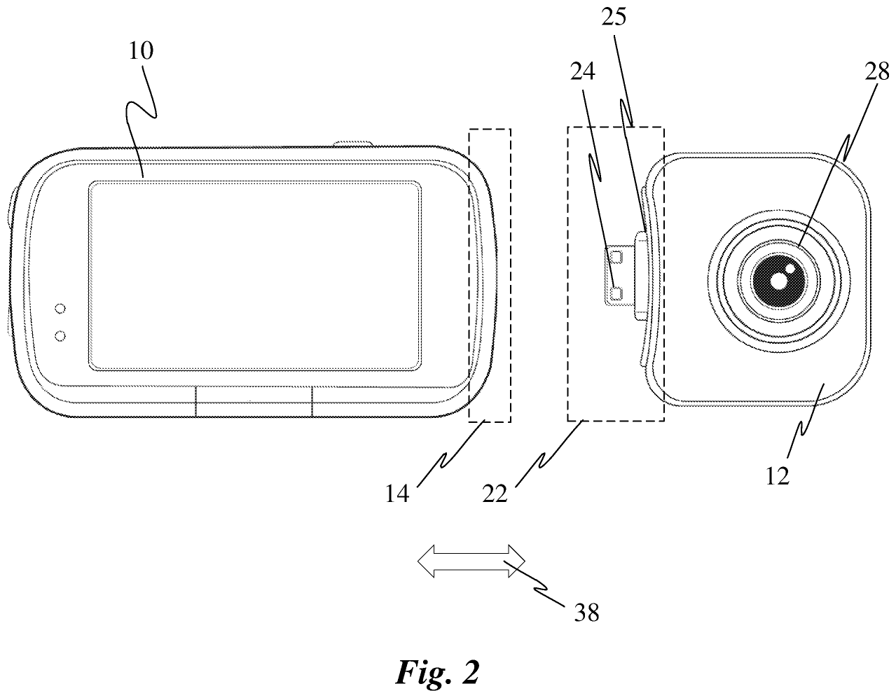

FIG. 2 is an illustrative schematic drawing comprising a rear view of the camera assembly when the first image capture device 10 and second image capture device 12 are in the decoupled position. The direction of the view in this figure is substantially in the same direction as first direction 30 of FIG. 1.

In the illustrated example, the first 10 and second 12 image capture devices are electro-mechanically couplable by way of first 14 and second 22 couplings such that the first 26 and second 28 cameras are facing in two different directions (substantially the opposite direction in the illustrated example). Thus, when the first image capture device 10 and second image capture device 12 of the camera assembly are in a coupled configuration, the first 26 and second 28 cameras are configured to form a bidirectional camera assembly. In this manner, the camera assembly can be used to record images in two different (opposite) directions, e.g. a forward and rearward direction. For example, when the camera assembly is located in a vehicle, the first 26 and second cameras 28 can be configured to capture images in front of the vehicle and from behind the vehicle (through the vehicle cabin) when mounted on a vehicle windscreen. When the illustrated example is used as a “dashcam”, this provides the user with the ability to simultaneously record video footage in a forward and rearward direction.

In arrangements comprising magnetic elements, when the first 10 and second 12 image capture devices are brought into proximity with each other in the third direction 38 tangential to the directions 30, 32 there is an attractive force between the first coupling 14 and the second coupling 22. As previously mentioned, the attractive force is a magnetic force originating due to the first and second magnets of the first coupling 14 and a magnetic material of the second coupling 22 or the third 34 and fourth 36 magnets of the second coupling 22 and a magnetic material of the first coupling 14. In alternate examples, the magnetic force could be between pairs of magnets in each image capture device.

In this illustrative example, the magnetic force between the first 14 and second 22 couplings is configured to guide the first 10 and second 12 image capture devices together into a coupled configuration. The connectors 22, 24 are configured to act, in combination with the magnetic force between the first 14 and second 22 couplings, to guide the first coupling 14 relative to the second coupling 22 during a coupling/decoupling operation.

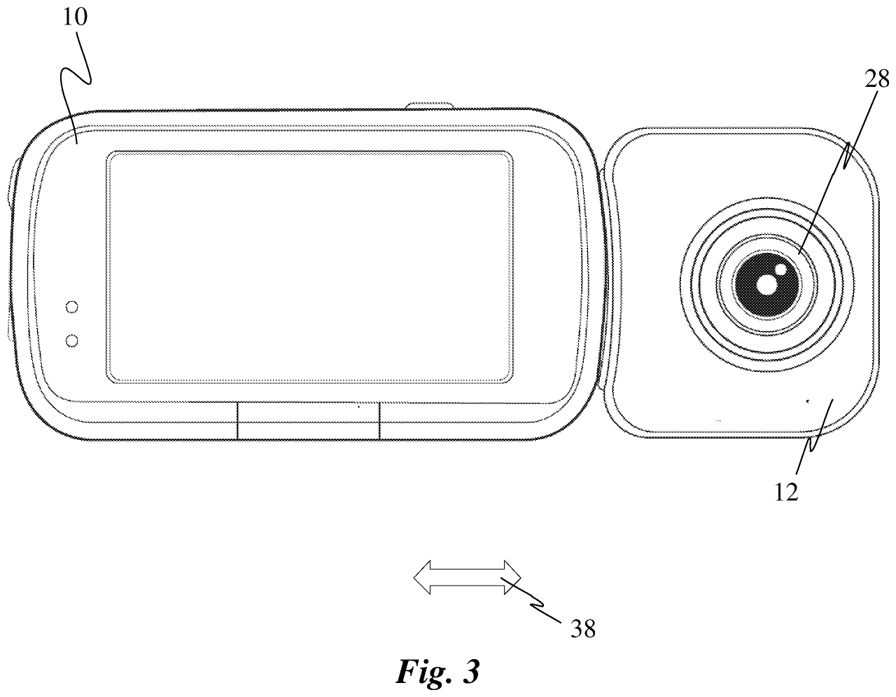

FIG. 3 is an illustrative schematic drawing comprising a rear view projection of a camera assembly when the first image capture device 10 and second image capture device 12 are in a coupled position. The direction of the view in this figure is substantially in the same direction as first direction 30 of FIG. 1.

When the first 14 and second 24 couplings are fully engaged with each other they provide mechanical support so as to maintain the positions relative between the first 10 and second 12 image capture devices. In the event that external forces are applied to the camera assembly, the presence of the magnetic force and structural support between the first 14 and second 24 couplings prevent the separation of the first and second camera devices. This may be advantageous when using a high definition video connection to transmit the images captured by the second image capture device to the first image capture device. Any movement of the two devices relative to each other may disconnect the data and power link between the two and reduce the reliability of the data and images captured.

Any references made herein to orientation (e.g., top, bottom, upper, lower, front, back, and rear) are made for the purposes of describing relative spatial arrangements of the features of the apparatus and are not intended to be limiting in any sense.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, the terms “a” or “an” are employed to describe elements and components of the invention. This is done merely for convenience and to give a general sense of the invention. This description should be read to include one or at least one and the singular also includes the plural unless it is obvious that it is means otherwise.

In view of the foregoing description it will be evident to a person skilled in the art that various modifications may be made within the scope of the invention. For example, embodiments in accordance with the invention are not limited to any of the particular materials disclosed herein. Other materials suitable for performing the function described herein for a particular material may also be utilized in embodiments of the invention.

The scope of the present disclosure includes any novel feature or combination of features disclosed therein either explicitly or implicitly or any generalisation thereof irrespective of whether, or not it relates to the claimed invention or mitigate against any or all of the problems addressed by the present invention. The applicant hereby gives notice that new claims may be formulated to such features during prosecution of this application or of any such further application derived therefrom. With reference to the appended claims, features from dependent claims may be combined with those of the independent claims and features from respective independent claims may be combined in any appropriate manner and not merely in specific combinations enumerated in the claims.

What is claimed is:

1. A camera assembly, comprising:
a first image capture device operative to capture images in a first direction, the first image capture device comprising a first coupling configured to receive a complementary coupling of a second image capture device;
the first image capture device further comprising a housing, a portion of which comprises a recessed area in the surface of the housing of the first image capture device;
a second image capture device removably coupleable to said first image capture device and operative to capture images in a second direction different to the first direction, the second image capture device comprising a second coupling;
the second image capture device further comprising a housing, a portion of which comprises a lug extending from the surface of the housing,
wherein the first and second couplings are configured to electro-mechanically couple the second image capture device to the first image capture device by complementary inter-engagement of said first and second couplings;
wherein the lug and the recessed area act to provide a guide for inter-engaging the first coupling with the second coupling; and
further wherein images captured by said second image capture device are transferrable to said first image capture device via coupled first and second couplings.

2. The camera assembly according to claim 1, wherein said first coupling comprises a female configuration and said second coupling comprises a male configuration.

3. The camera assembly according to claim 1, wherein said first and second image capture devices are operative to capture a series of images comprising video footage.

4. The camera assembly according to claim 1, wherein said first coupling is further configured to receive a coupling element of a data transfer element to communicate images captured by said first image capture device and/or second image capture device to a remote device via said data transfer element.

5. The camera assembly according to claim 1, wherein said first coupling and second coupling comprise couplings compatible with video transfer connectors.

6. The camera assembly according to claim 5, wherein said first coupling and second coupling comprise High Definition video connectors.

7. The camera assembly according to claim 5, wherein said first coupling comprises a plurality of connectors and said second coupling comprises a plurality of complementary connectors, each one of said plurality of complementary connectors engageable with a corresponding one of said plurality of connectors.

8. The camera assembly according to claim 7, wherein at least one of said plurality of connectors is unassigned and at least one of said plurality of complementary connectors is unassigned and further wherein transfer of images captured by said second image capture device to said first image capture device is via said at least one unassigned complementary connectors and respective unassigned connectors.

9. The camera assembly according to claim 1, wherein said first and second image capture devices further comprise magnetic coupling elements disposed on respective opposed surfaces thereof that are opposed when said first and second image capture devices are coupled, said magnetic coupling elements arranged to attract said first image capture device to said second image capture device, and vice versa, to maintain a coupling orientation through a coupling/decoupling operation and to removably couple said first image capture device to said second image capture device.

10. The camera assembly according to claim 9, wherein said magnetic coupling elements comprise rare-earth magnets.

11. The camera assembly according to claim 9, wherein said rare-earth magnets comprise neodymium.

12. The camera assembly according to claim 1, wherein said camera assembly comprises a bi-directional camera assembly.

13. The camera assembly according to claim 1, wherein said second direction is an opposite direction to said first direction.

14. A first image capture device for use in a camera assembly according to claim 1, the first image capture device operative to capture images in a first direction, the first image capture device comprising:
a first coupling configured to receive a complementary coupling of a second image capture device operative to capture images in a second, different direction and to removably couple said first image capture device to a second image capture device;
the first image capture device further comprising a housing, a portion of which comprises a recessed area in the surface of the housing;
the first coupling further configured to electro-mechanically couple the first image capture device to a second image capture device by complementary inter-engagement of said first coupling with a second coupling of a second image capture device;
wherein the recessed area acts to provide a guide for inter-engagement of the first coupling with the second coupling by complementary inter-engagement with a lug extending from the surface of a housing of a second image capture device; and
further wherein images captured by a second image capture device coupled to the first image capture device are transferrable to said first image capture device via a coupling between the first coupling and a complementary coupling of a second image capture device.

15. The first image capture device according to claim 14, wherein said first coupling comprises a female configuration.

16. The first image capture device according to claim 14, wherein said first image capture device is operative to capture a series of images comprising video footage.

17. The first image capture device according to claim 14, wherein said first coupling is further configured to receive a coupling element of a data transfer element to communicate captured images to a remote device via said data transfer element.

18. The first image capture device according to claim 14, wherein said first coupling comprises a coupling compatible with a video transfer connector.

19. The first image capture device according to claim 18, wherein said first coupling comprises a High Definition video connector.

20. The first image capture device according to claim 18, wherein said first coupling comprises a plurality of connectors, each one of said plurality of connectors engageable with a corresponding one of a plurality of complementary connectors of a second coupling of a second image capture device.

21. The first image capture device according to claim 20, wherein at least one of said plurality of connectors is unassigned and further wherein transfer of images captured by a second image capture device to said first image capture device is via at least one unassigned complementary connector of a second coupling of a second image capture device and respective unassigned connector of said first image capture device.

22. The first image capture device according to claim 14, wherein said first image capture device further comprises a magnetic coupling element disposed on a surface thereof that is opposite an opposing surface of a second image capture device when said first and second image capture devices are coupled, said magnetic coupling element arranged to attract said first image capture device to a second image capture device, and vice versa, to maintain a coupling orientation through a coupling/decoupling operation and to removably couple said first image capture device to a second image capture device.

23. The first image capture device according to claim 22, wherein said magnetic coupling element comprises a rare-earth magnet.

24. The first image capture device according to claim 23, wherein said rare-earth magnet comprises neodymium.

25. The first image capture device according to claim 14, wherein said first direction is an opposite direction to said second direction.

26. A second image capture device for use in a camera assembly according to claim 1 and removably couplable to a first image capture device for capturing images in a first direction, the second image capture device removably couplable to the first image capture device and operative to capture images in a second direction different to the first direction, the second image capture device comprising:
a second coupling, the second image capture device further comprising a housing, a portion of which comprises a lug extending from the surface of the housing,
the second coupling further configured to electro-mechanically couple the second image capture device to the first image capture device by complementary inter-engagement of said second coupling with a first coupling of a first image capture device,
wherein the lug acts to provide a guide for inter-engagement of the first coupling with the second coupling by complementary inter-engagement with a recessed area in the surface of the housing extending from the surface of a housing of a first image capture device; and
further wherein images captured by the second image capture device coupled to a first image capture device are transferrable to a first image capture device via a coupling between the second coupling and a complementary coupling of a first image capture device.

27. The second image capture device according to claim 26, wherein said second coupling comprises a male configuration.

28. The second image capture device according to claim 26, wherein said second image capture device is operative to capture a series of images comprising video footage.

29. The second image capture device according to claim 26, wherein said second coupling comprises a coupling compatible with a video transfer connector.

30. The second image capture device according to claim 29, wherein said second coupling comprises a High Definition video connector.

31. The second image capture device according to claim 29, wherein said second coupling comprises a plurality of connectors, each one of said plurality of connectors engageable with a corresponding one of a plurality of complementary connectors of a first coupling of a first image capture device.

32. The second image capture device according to claim 31, wherein at least one of said plurality of connectors is unassigned and further wherein transfer of images captured by the second image capture device to a first image capture device is via at least one unassigned connector of the second coupling of the second image capture device and a respective unassigned complementary connector of a first coupling of a first image capture device.

33. The second image capture device according to claim 26, wherein said second image capture device further comprises a magnetic coupling element disposed on a surface thereof that is opposite an opposing surface of a first image capture device when said second image capture device and a first image capture device are coupled, said magnetic coupling element arranged to attract said second image capture device to a first image capture device, and vice versa, to maintain a coupling orientation through a coupling/decoupling operation and to removably couple said second image capture device to a first image capture device.

34. The second image capture device according to claim 33, wherein said magnetic coupling element comprises a rare-earth magnet.

35. The second image capture device according to claim 34, wherein said rare-earth magnet comprises neodymium.

36. The second image capture device according to claim 26, wherein said second direction is an opposite direction to said first direction.
